(19) United States
(12) Patent Application Publication
(10) Pub. No.: US 2008/0097263 A1
(43) Pub. Date: Apr. 24, 2008

(54) DEVICE FOR MECHANICAL STIMULATION OF THE FOOT SUPPORT AREAS

(76) Inventors: Anatoly Ivanovich Grigoriev, Moscow (RU); Inesa Benediktovna Kozlovskaya, Moscow (RU); Evgeny Petrovich Tihomirov, Moscow (RU); Elena Illarionovna Sorokina, Ramenskoe (RU); Evgeniya Nikolaevna Yarmanova, Zhukovsky (RU)

Correspondence Address: FITCH EVEN TABIN AND FLANNERY, 120 SOUTH LA SALLE STREET, SUITE 1600, CHICAGO, IL, 60603-3406, US

(21) Appl. No.: 11/950,226

(22) Filed: Dec. 4, 2007

Related U.S. Application Data
(63) Continuation of application No. 11/911,320.

(51) Int. Cl. A61H 9/00; A43B 13/38

(52) U.S. Cl. 601/151; 36/43

(57) ABSTRACT

A device for mechanical stimulation of the foot support zones comprises four pneumatic chambers, two chambers being for each one of the feet, to create pressure to be exerted on the foot support zones, which chambers are equipped with valves and are coupled, via a receiver, to a pressure source, which source in turn is coupled to a control unit that controls the pressure-varying modes in the pneumatic chambers. The pneumatic chambers are intended to be disposed within footwear in the heel and tarsus area, and are coupled, through suitable pipelines, to a receiver; the pneumatic chambers being implemented such that when air is supplied, their volume is increased only in the direction perpendicular to the foot sole. The control unit comprises a microprocessor operated by a program that controls the air supply to the pneumatic chambers according to various modes of walking or run within the pneumatic chambers to the atmospheric pressure value; and said control unit is connected to a control input of the control valve, of the pressure sensor via the interface, and to a pressure source driver.

This application is a continuation of U.S. patent application Ser. No. 11/911,320, filed Oct. 11, 2007, which is a U.S. national phase application filed under 35 U.S.C. § 371 of International Application PCT/RU2005/000188, filed Apr. 12, 2005, designating the United States, which applications are hereby incorporated by reference herein their entirety.

### FIELD OF THE INVENTION

The invention relates to the art of medical instrument engineering, and can be suitably used for mechanical stimulation of the foot support areas, i.e. the invention can be used in the medical fields that require prevention or treatment of disorders of locomotion, or of the walking and run biomechanics.

Such disorders generally affect the patients who have not used their legs to support themselves for a long time. These can be a bed-ridden patient or a spaceman staying in the zero-gravity state. Neurological patients may also be subjected to such condition.

### BACKGROUND OF THE INVENTION

Removal of the support loads on patient's feet during a prolonged bed rest, or on spaceman's feet in the zero-g state is accompanied by a number of undesired alterations in morphology of muscles and bones, and in the control movement system. Such alterations relate to the foot sensory system, shin muscular system, osseous structure; and some alterations occur even in the human posture regulation system.

“Deprivation of senses” emerging under said conditions becomes the cause of the absence of the initial link of the reflex arch that underlies the movement control. The absence of the uplink pulses from the foot mechanoreceptors brings about the conditions of undesired alterations in the locomotion system.

Known is a “device for rehabilitation of the locomotor apparatus in the zero-gravity environment” (see, e.g. RU Patent 2148981 Cl, Jul. 14, 2000), comprising two “pneumatic boots”, each being implemented as a sole having an elastic supinator, and a multi-chamber sleeve to squeeze the foot; pneumatic chambers to create the pressure to be exerted on the foot support areas; three pneumatic chambers being for each one of the feet, rigidly secured on the sole, provided with control valves and coupled, via a receiver, to a pressure source, which source in turn is coupled to a control unit that controls the pressure-varying modes in the pneumatic chambers; and pressure sensors connected, via an interface, to the pressure source. This device is operated through excitation of the human foot receptor zones when said zones are subjected to the action of pneumatic-mechanical pressure in the pulse mode.

This prior-art device has a number of drawbacks.

The device disclosed in said patent can be used only individually, for example, it can be used for a spacemen, and its use in any clinical environment for a plurality of patients is rather difficult due to the following reasons.

The device is intended for applying a local pressure on the anatomically characteristic foot zones. Said “pneumatic boots” are made individually for each patient, and “pneumatic chambers” are positioned and secured on particular places that correspond to zones of aggregation of Vater-Pacini corpuscles on the foot sole of a patient to whose size this pneumatic boot is made. The device must be manufactured in view of individual anatomic features of each patient's foot. First of all, sizes of foot length and width, and also possible deformities characteristic of some illnesses are taken into account.

The foot-squeezing sleeves are configured to draw the sole to the foot, but said sleeves do not cause excitation of mechanoreceptors on the foot dorsal side, which mechanoreceptors have no relation to organization of the support reaction and to formation of the reflex arch that underlies the locomotion control. Thus, the impulse mechanical actions are effected on the foot both from below and above, i.e. the foot is squeezed omnidirectionally, and as the sleeves provide the contact surface area greater than that provided by pneumatic chambers, then the pressure exerted from above is perceived as being stronger than the pressure acting on the sole. The presence of sleeves results in generation of the non-physiological, undesired mechanical pressure on the foot, which pressure causes a patient's negative emotional reaction.

Said device has a complicated design, for it comprises three pneumatic chambers in each pneumatic boot: one module being for the heel area, and two modules (the lateral and medial modules) being for the boot metatarsus portion. Each pneumatic chamber has its own operation-maintenance system, comprising a separate air-delivery line, a valve, a unit in a microprocessor. But the anatomical arrangement of Vater-Pacini corpuscles are known to appear in the foot metatarsus zone as two spots (the medial and lateral spots), and there is no functional difference between these aggregations of receptors. Such arrangement of Vater-Pacini corpuscles is caused by the anatomic setup.

Said prior art device is not capable to ensure the complete release of minimal pressure that is useless for adaptation of the receptors. Persistent level of pressure in said pneumatic chambers diminishes the pressure differential, and said pressure can be considered as adverse.

Said device includes two receivers and provides two pressure levels—minimal and maximal levels. The second-receiver feature complicates the device design. The pressure acting on the VaterPacini corpuscle zones, while walking and run, is generated only in contact with a support, and any other time this pressure is zero. Said pressure in the device must be released to be reduced to the atmospheric pressure. For this reason the presence of the minimal-pressure receiver is not justified.

Pneumatic chambers are disposed in the insole body, which circumstance restricts the pneumatic chamber travel and weakens the sense of pressure.

Vater-Pacini corpuscles are irritated or excited practically simultaneously when they contact a support. For this reason the load-applying members in the device metatarsus portion can be united into single member, which approach will simplify the design significantly and improve its reliability.

### SUMMARY OF THE INVENTION

This invention is directed to provision of a device for mechanical stimulation of the foot support zones, which device will be a more efficient, have an higher manufacturability and be more readily used. A greater efficiency is achieved through a physiologically improved action on the receptors, which in turn provides better simulation of the walking or run modes. Said physiologically improved action to be applied by the claimed device is obtained by a more correct pressure on a foot owing to elimination of any pressure on the foot dorsal side, and also by elimination of minimal pressure in the device system. Manufacture and use of the claimed device is rendered more simple and more ready for being used by elimination of the necessity to make any individual footwear, by the possibility to use the available footwear, by exclusion of any second receiver and one pneumatic chamber.

Said object of the claimed invention is to be attained by a device for mechanical stimulation of the foot support zones, comprising: pneumatic chambers to create pressure to be exerted on the foot support zones, which mechanical chambers are provided with valves and are coupled, via a receiver, to a pressure source, which source in turn is coupled to a control unit that controls the pressure-varying modes in the pneumatic chambers;

characterized in that said device for mechanical stimulation further comprises:

four pneumatic chambers, two pneumatic chambers being for each one of the feet, said pneumatic chambers configured to be disposed within a footwear article in the area of heel and tarsus, wherein said pneumatic chambers are connected through suitable pipelines to a receiver; the pneumatic chambers being implemented such that when air is supplied, the volume of the pneumatic chamber is increased only in the direction perpendicular to the foot sole;

the receiver is provided with a control valve and a pressure sensor;

the control unit comprises a microprocessor operated by a program that controls the air supply to the pneumatic chambers according to various modes of walking or run within the pneumatic chambers; and said control unit is connected, to a control input of the control valve of the receiver and to the pressure sensor of the receiver via the interface, and to a pressure source driver.

Preferably, said valves and the control valve are electropneumatic valves, maintaining a predetermined pressure in the pneumatic chambers and being operable to supply air from the receiver to the pneumatic chambers and release an pressure excess to atmospheric pressure according the pressure sensor readings.

Preferably the device further includes a pair of insoles to be disposed in a user's footwear and intended to secure the pneumatic chambers in the heel and tarsus area in accordance with individual zones of arrangement of Vater-Pacini corpuscles on the patient's foot.

Each said insole preferably comprises means for removably securing the pneumatic chambers.

Preferably the shape and sizes of one pneumatic chamber of said one pair correspond to those of the foot tarsus portion, and shape and size of the other pneumatic chamber of said pair correspond to those of the foot heel portion.

Preferably the device further comprising a display to visualize values of pressure in the receiver.

### BRIEF DESCRIPTION OF DRAWINGS

The invention hereinafter is explained by description of preferable embodiments of the device, referring to the accompanying drawings, wherein:

FIG. 1 schematically shows the inventive device for mechanical stimulation of the foot support zones;

FIG. 2 shows a diagram of a control circuit of the device for mechanical stimulation of the foot support zones.

### PREFERABLE EMBODIMENTS OF THE INVENTION

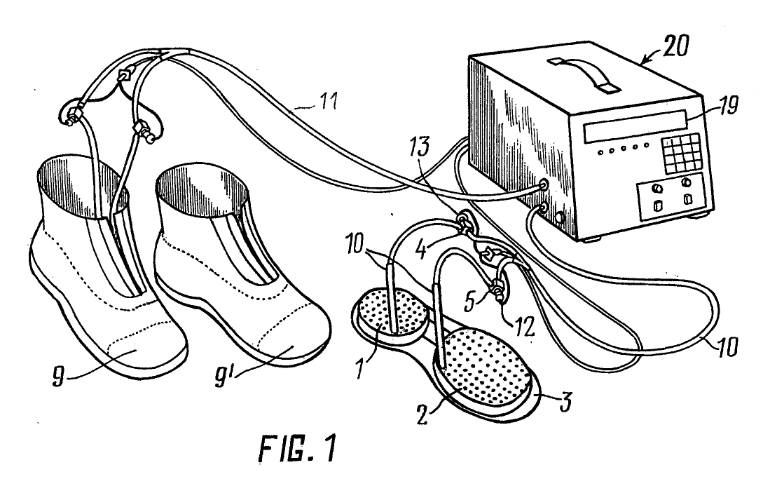

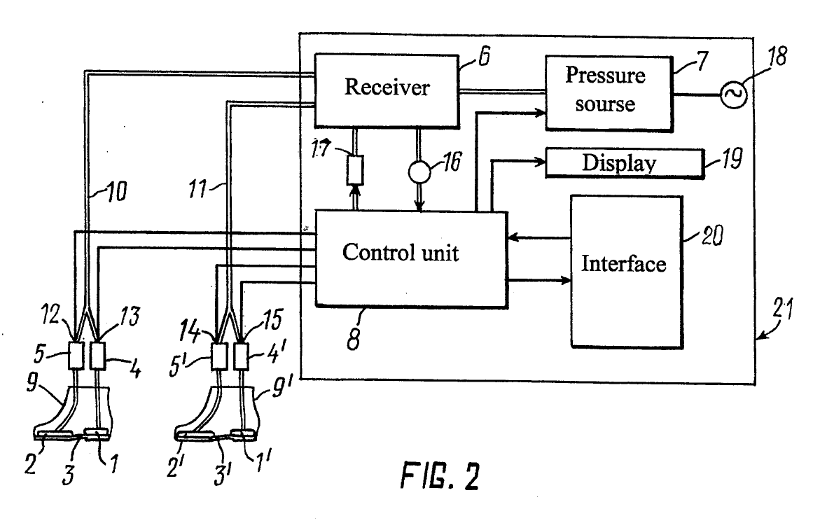

The inventive device for mechanical stimulation of the foot support zones comprises: four pneumatic chambers 1, 2, 1′, 2′ (FIGS. 1 and 2) configured to create the pressure to be exerted on the foot support zones. FIG. 1 shows one pair of pneumatic chambers 1, 2, disposed on insole 3. The other pair of pneumatic chambers 1′, 2′ is not shown, because it is inserted within a boot. Pneumatic chambers 1, 2, 1′, 2′ are provided with valves 4, 5, 4′, 5′ respectively and are coupled, via receiver 6, to pressure source 7, which source in turn is coupled to control unit 8 that controls modes of pressure variation in pneumatic chambers 1, 2 and 1′, 2′.

Pneumatic chambers 1, 2, 1′, 2′ are disposed in footwear 9, 9′ in the area of heel and tarsus, and are coupled, through suitable pipelines 10, 11 to receiver 6; said pneumatic chambers 1, 2 and 1′, 2′ being implemented such that when air is supplied thereto, their volume increases only in the direction perpendicular to the foot sole.

Control unit 8 comprises a microprocessor operable by a program that controls the air supply to pneumatic chambers 1, 2 and 1′, 2, in response to various modes of walking or run and depending on pressure release in the pneumatic chambers; said unit being connected to the control input of control valve 17 of the receiver and to the pressure sensor 16, via interface 19, respectfully, and to driver 18 of pressure source 7.

According to the invention, said valves 4, 5, 4′, 5′ and the control valve 17 are electropneumatic valves, maintaining a predetermined pressure in the pneumatic chambers and being operable to supply air from the receiver 6 to the pneumatic chambers 1, 2, 1′, 2′ and release an pressure excess to atmospheric pressure according the pressure sensor 16 readings.

The device further comprises a pair of insoles 3, 3′ to be inserted into user's footwear 9, 9′ and intended to secure the pneumatic chambers in the heel and tarsus area—in conformance with individual zones of arrangement of Vater-Pacini corpuscles on the patient's foot.

Each insole 3, 3′ includes means for removably securing the pneumatic chambers.

Shape and sizes of one pneumatic chamber 2, 2′ of said pair correspond to those of the foot metatarsus portion; and shape and sizes of the other pneumatic chamber 1,1′ of said pair correspond to those of the foot heel area.

The claimed device comprises display 20 (FIG. 1) to visualize values of pressure existing in the receiver 6.

The device includes a compressor that performs the function of the pressure source.

Pneumatic chambers 1, 2 and 1′, 2′ are the sealed chambers made of a rubber cloth. The lower portion of the pneumatic chambers has a pile band (not shown) attached thereon by an adhesive, using which band said chambers are secured to elastic flexible insole 3, with the secured complementary portion of the pile band.

Pneumatic chamber 2 is elongated, and its surface spreads to the medial and lateral zones of arrangement of Vater-Pacini corpuscles in a foot.

The presence of only two pneumatic chambers for one foot allows simplify the inventive device design.

As insoles 3, 3′ are inserted into patient's individual footwear, the possibility to arrange the pneumatic chambers in view of sizes and features of a patient's foot is provided. The possibility to use individual patient's footwear for treatment procedures is provided, and any tight adjustment is not required.

To simulate the actions exerted on a foot according to speed of run, the device must create the required pressure in the pneumatic chambers and release said pressure to zero within a very brief time.

The device ensures simulation of the pressure exerted on a foot during locomotions, the simulated conditions approximating the natural ones.

Interface 19 includes the integrally implemented keyboard.

Control unit 8 allows the device operate in the automatic mode according to a strict cyclogram, in the automatic mode according to a flexible program, and in the manual operation mode.

The manual mode provides the separate or simultaneous turning-on of the valves.

Pressure in the pneumatic chambers is set as required within the range of 0-0.4 kgf/cm², increments being 0.01 kg/cm2.

Liquid-crystal display 20 is disposed on a housing 21 and has two lines that accommodate twenty alphanumeric symbols on each line. The display is adapted to provide imaging of the following information: tuning-on of each one of the valves, a predetermined and current pressure in the receiver, an exerted action mode (“walking-1”, “walking-2”, “run”), a predetermined time period of a cycle, an exerted action, a remaining cycle time period.

The following values are reproduced in the modes according to strict cyclograms: pace of walking (run), duration of single stride, duration of dual stride, duration of the support phase of each leg, duration of the dual-support phase (for walking), duration of the transfer phase, duration of the leap phase (for run); speed of motion being simulated within the following values: for “walking-1” the rate is 75 strides/min, for “walking-2” the rate is 120 strides/min, the run motion rate is 150 strides/m in.

The device is operated as follows.

The operation time period of the claimed system is preset within the range of 1-60 min, increments being 1 min long, the cycle time count beginning from the moment a predetermined pressure has been generated in the receiver. Information on turning-on of the valves is duplicated by the light signals emitted by LEDs: “walking-1” (75 strides/min), “walking-2” (120 strides/min), run (150 strides/min); the cycle time.

“Start” button is pressed, the program is launched, the compressor starts to operate. A pressure determined by control unit 8 is created in receiver 6. The electropneumatic valves 4, 5, 4′, 5′ open when the receiver's 6 pressure sensor 7 sends a signal whose value exceeds a predetermined pressure value.

The pressure from receiver 6 is transmitted, via suitable pipelines, into pneumatic chambers 1, 2, 1′, 2′ at the moments when electropneumatic valves 4, 5, 4′, 5′ are open. Pressure out of the pneumatic chambers is released when pressure in pneumatic chambers 1, 2, 1′, 2′ reaches a predetermined value, then the electropneumatic valve closes. A required pressure is maintained for a predetermined time period according to an applied cyclogram, whereafter the electropneumatic valve opens again, and the pressure is released to atmospheric value. Electrical communication of the electric valves with control unit 8 ensures execution of a given program of a séance: rate of activations of each one of 4 pneumatic valves (opening/closure of inlet and outlet), provision of the required time intervals, pauses between activations of 2 valves on each leg, between activations of the valves on the right and left legs—characteristic of the predetermined modes (walking-1, walking-2, run).

In the course of a seance, operators perform monitoring of the following information imaged on the display: mode name, activation of each one of the valves is indicated when a corresponding LED is lit; predetermined and current values of pressure in the receiver, a predetermined duration of cycle, remaining time of cycle.

After expiration of a predetermined time (1 hour at most), power supply is disconnected automatically.

1. A device for mechanical stimulation of foot support zones, comprising:
pneumatic chambers to create pressure to be exerted on the foot support zones, which mechanical chambers are provided with valves and are coupled, via a receiver, to a pressure source, which source in turn is coupled to a control unit that controls pressure-varying modes in the pneumatic chambers;
characterized in that said device for mechanical stimulation further comprises:
four pneumatic chambers, two pneumatic chambers being for each one of the feet, said pneumatic chambers configured to be disposed within a footwear article in area of heel and tarsus, wherein said pneumatic chambers are connected through suitable pipelines to a receiver; the pneumatic chambers being implemented such that when air is supplied, the volume of the pneumatic chamber is increased only in the direction perpendicular to foot sole;
the receiver is provided with a control valve and a pressure sensor;
the control unit comprises a microprocessor operated by a program that controls air supply to the pneumatic chambers according to various modes of walking or run within the pneumatic chambers; and said control unit is connected to a control input of the control valve of the receiver and to the pressure sensor of the receiver via an interface, and to a pressure source driver.

2. The device as claimed in claim 1, characterized in that said valves and the control valve are electropneumatic valves, maintaining a predetermined pressure in the pneumatic chambers and being operable to supply air from the receiver to the pneumatic chambers and release an pressure excess to atmospheric pressure according the pressure sensor readings.

3. The device as claimed in claim 1, characterized in that the device further includes a pair of insoles to be disposed in a user's footwear and intended to secure the pneumatic chambers in the heel and tarsus area in accordance with individual zones of arrangement of Vater-Pacini corpuscles on the patient's foot.

4. The device as claimed in claim 3, characterized in that each insole preferably comprises means for removably securing the pneumatic chambers.

5. The device as claimed in claim 1, characterized in that shape and sizes of one pneumatic chamber of said one pair correspond to those of the foot tarsus portion, and shape and size of the other pneumatic chamber of said pair correspond to those of the foot heel portion.

6. The device as claimed in claim 1, characterized in further comprising a display to visualize values of pressure in the receiver.
